(19) United States
(12) Patent Application Publication
(10) Pub. No.: US 2025/0343496 A1
(43) Pub. Date: Nov. 6, 2025

(54) MOTOR CONTROL DEVICE

(71) Applicant: Mitsubishi Electric Corporation, Tokyo (JP)

(72) Inventors: Hiroyuki SEKIGUCHI, Tokyo (JP); Takashi KAI, Tokyo (JP); Hidetoshi IKEDA, Tokyo (JP); Sho UENO, Tokyo (JP)

(73) Assignee: Mitsubishi Electric Corporation, Tokyo (JP)

(21) Appl. No.: 18/869,860

(22) PCT Filed: Jun. 10, 2022
(86) PCT No.: PCT/JP2022/023527

§ 371 Date: Nov. 27, 2024

(51) Int. Cl. H02P 23/14

(52) U.S. Cl. CPC H02P 23/14

(57) ABSTRACT

A motor control device includes a feedforward controller generating motor torque and position commands, an encoder outputting a motor position detection value, a machine-end sensor detecting a target object as a measurement value, a signal processor calculating movable component position based on the measurement value as a machine-end position detection value, and a feedback torque command generation unit generating a feedback torque command based on the machine-end and motor position detection values and the motor position command. When a positional relationship between the movable component and a target point is undetectable, the feedback torque command is generated based on the motor position detection value and the motor position command, and when the positional relationship is detectable, the feedback torque command is generated based on the motor and machine-end position detection values, the motor position command, and a signal adding a time delay to the motor position command.

### FIELD

The present disclosure relates to a motor control device that positions a movable component at a target point.

### BACKGROUND

An apparatus for manufacturing an electronic device or a semiconductor device needs to perform positioning to move and stop a movable component included in the apparatus to and at a target point quickly and highly accurately. For example, an apparatus such a chip mounter or a die bonder for mounting an electronic part or an integrated circuit (IC) chip at a target mount position on a substrate performs positioning of the electronic part or the IC chip held at an end of a movable component, at the target mount position on the substrate with high accuracy, and then mounts the electronic part or the IC chip on the substrate. In regard to this apparatus, a mounting head including an adsorption nozzle for adsorbing the electronic part or the IC chip corresponds to the movable component, and the movable component is moved in a predetermined area in the apparatus by a combination of a rotary motor and a linear motion mechanism (or straight motion mechanism) or a linear motor mechanism. The mounting head moves to an area for supplying the electronic part or the IC chip, adsorbs the electronic part or the IC chip using an adsorption nozzle, then moves to above a target mount position on a substrate, and releases the electronic part or the IC chip from the adsorption nozzle to thus mount the electronic part or the IC chip on the substrate.

The mounting head is positioned through feedback control on a basis of a value detected by an encoder for detecting the rotational position of the motor or the position of the linear motor used for moving the mounting head. That is, no feedback control is performed by directly detecting the positional relationship between the target mount position on the substrate and either the adsorption nozzle included in the mounting head or the electronic part or the like adsorbed by the adsorption nozzle.

In recent years, electronic parts and IC chips have increasingly been reduced in size, thereby requiring more accurate positioning. On the other hand, the substrate used in mounting may have a different target mount position on the substrate from product to product due to misalignment of the substrate placement position or deformation at the substrate placement position. Accordingly, positioning based only on a design value of the substrate and a detection value signal from an encoder described above may cause a deviation between the mounting position of an electronic part or an IC chip and a predetermined position on the substrate.

In addition, to increase productivity, a chip mounter and a die bonder are required not only to increase accuracy in positioning, but also to reduce the time from adsorption to release of an electronic part or an IC chip. For example, the control device described in Patent Literature 1 analyzes an image obtained by imaging an area including an object to be position-controlled and a target point, generates measurement data of a positional relationship between the object to be controlled and the target point, and performs positioning using this measurement data and an encoder value of the motor. Image processing of analyzing an image for obtaining the measurement data takes a certain time from obtaining the image until the measurement data is obtained, which will be a dead time, and thus prevents achievement of high-speed control. Thus, at a timing when measurement data and an encoder value cannot be simultaneously obtained, the control device described in Patent Literature 1 calculates a latest positional deviation between the target point and the object to be controlled, using data of previously calculated positional deviation between the target point and the object to be controlled, an encoder value used for calculation of this data, and a latest encoder value.

### CITATION LIST

### Patent Literature

Patent Literature 1: Japanese Patent Application Laid-open No. 2019-3388

### SUMMARY OF INVENTION

### Problem to be Solved by the Invention

The control device described in Patent Literature 1 is capable of performing fast and accurate positioning control. However, suffering a disturbance having a period shorter than the dead time may cause an error in the estimated value of positional deviation between a target point and the object to be controlled, and may thus destabilize the feedback control system that uses the estimated value.

In addition, detection of a positional deviation using image processing has a problem of limitation on the area in which the positional deviation is detectable. For example, to image an area of 100 mm×100 mm with every 1 pixel equivalent to 1 μm, a camera used for obtaining an image needs to have a resolution of ten billion pixels. Accordingly, a very high performance camera and very high performance image processing are required. The control device described in Patent Literature 1 captures an image of a target point using a fixed camera, thereby limiting the area needed to be imaged. However, a chip mounter needs to be positioned at multiple target points on a substrate, and a fixed camera hardly supports multiple target points. A method is therefore conceived in which a camera is installed on a movable component to allow the camera to move with the movable component to thereby include multiple target points in respective imaging areas. Such configuration prevents a target point from being included in an imaging area before the movable component comes near the target point. This prevents performing control using a detection result obtained by image processing, thereby permitting control to be performed using only a detection result from an encoder when the target point is outside the imaging area. The control scheme then needs to be switched to one using a detection result obtained by image processing after the movable component has come near the target point. Upon switching of the control scheme, the detection result from the encoder may significantly deviate from the detection result obtained by image processing due to an effect of dead time, and may thus cause a rapid movement of the movable component upon switching of the control scheme.

Moreover, a similar problem will arise also in a case where a relative positional relationship between the target point and the movable component is obtained using a sensor other than a camera so as to provide control. For example, in a case of a linear scale capable of detecting a position installed at an end of a machine, there may be a restriction on the position of attachment of the scale, or a lot of time may be required to obtain position information depending on a type of the scale, thereby presenting a similar problem. Use of a laser displacement sensor also presents a similar problem.

The present disclosure has been made in view of the above, and it is an object of the present disclosure to provide a motor control device capable of performing fast and accurate positioning.

### Means to Solve the Problem

In order to solve the above-described problems and achieve the object, the present disclosure is a motor control device that drives a motor on a basis of a position command to move a movable component to a target point specified by the position command, the motor control device comprising: a feedforward controller to generate a motor torque command and a motor position command on a basis of the position command; an encoder to detect a position of the motor and to output a motor position detection value signal representing the position; a machine-end sensor to detect a target object present in a certain area including the movable component and output a measurement value signal representing a result of detection; a signal processor to calculate a position of the movable component with the target point used as a reference on a basis of the measurement value signal and output a machine-end position detection value signal representing a result of calculation; a feedback torque command generation unit to generate a feedback torque command for correcting the motor torque command, on a basis of the machine-end position detection value signal, the motor position detection value signal, and the motor position command; and a torque signal adder to add the motor torque command and the feedback torque command to generate a torque command directed to the motor. When the machine-end sensor is in a first state, the feedback torque command generation unit generates the feedback torque command on a basis of the motor position detection value signal and the motor position command, and when the machine-end sensor is in a second state, the feedback torque command generation unit generates the feedback torque command on a basis of the motor position detection value signal, the machine-end position detection value signal, the motor position command, and a signal. obtained by adding a time delay to the motor position command. The first state is a state in which a relative positional relationship between the movable component and the target point is undetectable by the machine-end sensor. The second state is a state in which the relative positional relationship between the movable component and the target point is detectable by the machine-end sensor.

### Effects of the Invention

A motor control device according to the present disclosure provides an advantage in capability of performing fast and accurate positioning.

### BRIEF DESCRIPTION OF DRAWINGS

FIG. 1 is a block diagram illustrating an exemplary configuration of a motor control device according to a first embodiment.

FIG. 2 is a diagram illustrating an example of relationship between a movable component and a machine-end sensor of the motor control device according to the first embodiment.

FIG. 3 is a diagram illustrating an exemplary configuration when a laser displacement meter is used as the machine-end sensor of the motor control device according to the first embodiment.

FIG. 4 is a diagram illustrating an exemplary configuration when a linear scale is used as the machine-end sensor of the motor control device according to the first embodiment.

FIG. 5 is a flowchart illustrating an example of operation of the motor control device according to the first embodiment.

FIG. 6 is a diagram illustrating an example of control circuit usable to implement the motor control device according to the first embodiment.

FIG. 7 is a block diagram illustrating an exemplary configuration of a motor control device according to a second embodiment.

FIG. 8 is a block diagram illustrating an exemplary configuration of a motor control device according to a third embodiment.

FIG. 9 is a block diagram illustrating an exemplary configuration of a motor control device according to a fourth embodiment.

### DESCRIPTION OF EMBODIMENTS

A motor control device according to embodiments of the present disclosure will be described in detail below with reference to the drawings.

### First Embodiment.

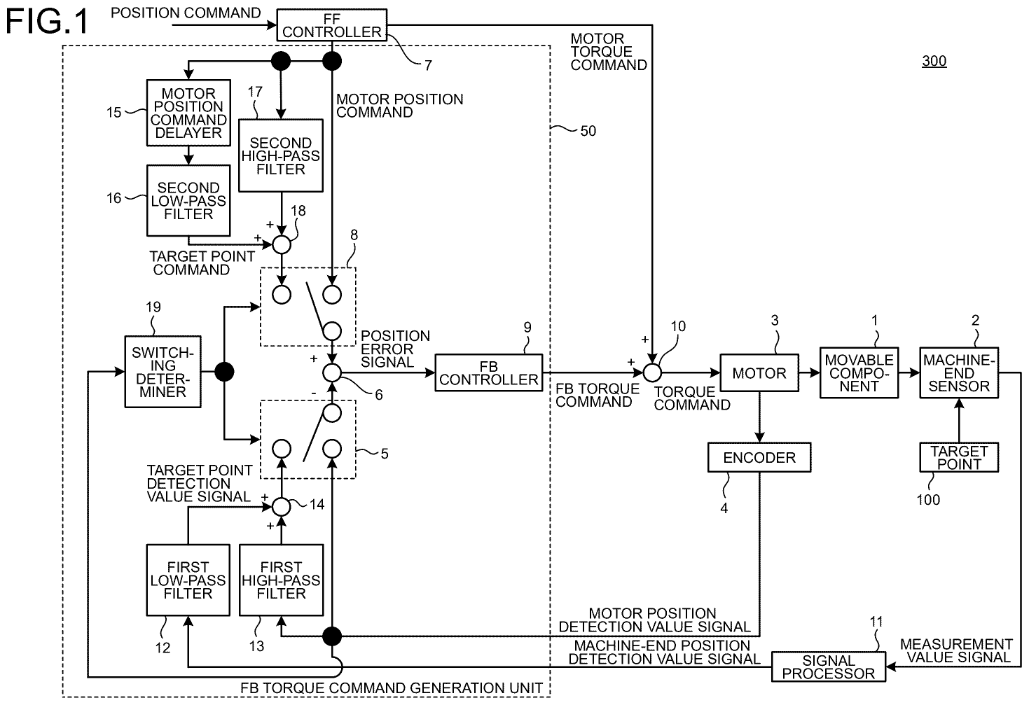

FIG. 1 is a block diagram illustrating an exemplary configuration of a motor control device 300 according to a first embodiment. The motor control device 300 illustrated in FIG. 1 is a device that performs positioning control to move a movable component 1 to a target point 100, which is a position specified by a position command, by driving a motor 3 on the basis of the position command.

In the motor control device 300 illustrated in FIG. 1, the movable component 1 is mechanically coupled to the motor 3 to be moved to a desired position, i.e., the target point 100, by a movement of the motor 3. A machine-end sensor 2 is installed to be able to detect a target object present in a certain area. The certain area includes the movable component 1. When the target point 100 is included in this certain area, the machine-end sensor 2 detects the target point 100. An encoder 4 detects a position of the motor 3, generates a signal representing the position of the motor 3, and outputs this signal as a motor position detection value signal. The motor position detection value signal output by the encoder 4 is input to a position signal subtractor 6 via a detection value signal switcher 5. A feedforward (FF) controller 7 receives a position command for moving the movable component 1 to the target point 100, and generates and outputs a motor position command and a motor torque command. The motor position command is input to the position signal subtractor 6 via a command value switcher 8. The position signal subtractor 6 calculates a difference of an output value of the detection value signal switcher 5 relative to an output value of the command value switcher 8 to generate a position error signal, and inputs the position error signal to a feedback (FB) controller 9. The FB controller 9 calculates, on the basis of the position error signal, a FB torque command for correcting the position of the movable component 1. The FB torque command is input to a torque signal adder 10. The torque signal adder 10 adds the FB torque command to the motor torque command to correct the motor torque command, and outputs a motor torque command obtained by correction to the motor 3 as a torque command. The motor 3 generates torque according to the torque command output by the torque signal adder 10 to thus move the movable component 1.

The machine-end sensor 2 outputs, to a signal processor 11, a signal including information of a relative positional relationship between the movable component 1 and the target point 100. Note that the signal output by the machine-end sensor 2 includes the information of the relative positional relationship between the movable component 1 and the target point 100 when the target point 100 is included in an area detectable by the machine-end sensor 2, that is, when the machine-end sensor 2 is in a state of capable of detecting the target point 100. The signal processor 11 calculates the position of the movable component 1 with respect to the position of the target point 100 which is used as a reference on the basis of the information of the relative positional relationship between the movable component 1 and the target point 100, included in the output signal from the machine-end sensor 2. The signal processor 11 then generates and outputs a machine-end position detection value signal including information of the result of calculation. When the signal output by the machine-end sensor 2 includes no information of a relative positional relationship between the movable component 1 and the target point 100, the signal processor 11 may output a machine-end position detection value signal without a result of calculation or may skip outputting a machine-end position detection value signal. The machine-end position detection value signal is input to an adder 14 via a first low-pass filter 12. The first low-pass filter 12 passes a signal having a frequency lower than or equal to a predetermined frequency. In addition, the motor position detection value signal output from the encoder 4 is input to the adder 14 via a first high-pass filter 13. The first high-pass filter 13 passes a signal having a frequency higher than or equal to a predetermined frequency. The adder 14, which is a first adder of the motor control device 300, adds an input signal from the first low-pass filter 12 and an input signal from the first high-pass filter 13, and outputs a result of addition as a target point detection value signal. The target point detection value signal output by the adder 14 is input to the detection value signal switcher 5.

The motor position command output by the FF controller 7 is delayed for a predetermined time delay, i.e., by adding a retardation time thereto, by a motor position command delayer 15. The delayed signal is then input to an adder 18 via a second low-pass filter 16. The second low-pass filter 16 passes a signal having a frequency lower than or equal to a predetermined frequency. In addition, the motor position command output by the FF controller 7 is also input to the adder 18 via a second high-pass filter 17. The second high-pass filter 17 passes a signal having a frequency higher than or equal to a predetermined frequency. The adder 18, which is a second adder of the motor control device 300, adds an input signal from the second low-pass filter 16 and an input signal from the second high-pass filter 17, and outputs a result of addition as a target point command. The target point command output by the adder 18 is input to the command value switcher 8.

A switching determiner 19 determines which is to be output of two signals which are to be input to each of the detection value signal switcher 5 and the command value switcher 8, on the basis of the motor position detection value signal output by the encoder 4.

Note that in the motor control device 300, the detection value signal switcher 5, the position signal subtractor 6, the command value switcher 8, the FB controller 9, the first low-pass filter 12, the first high-pass filter 13, the adders 14 and 18, the motor position command delayer 15, the second low-pass filter 16, the second high-pass filter 17, and the switching determiner 19 constitute a FB torque command generation unit 50.

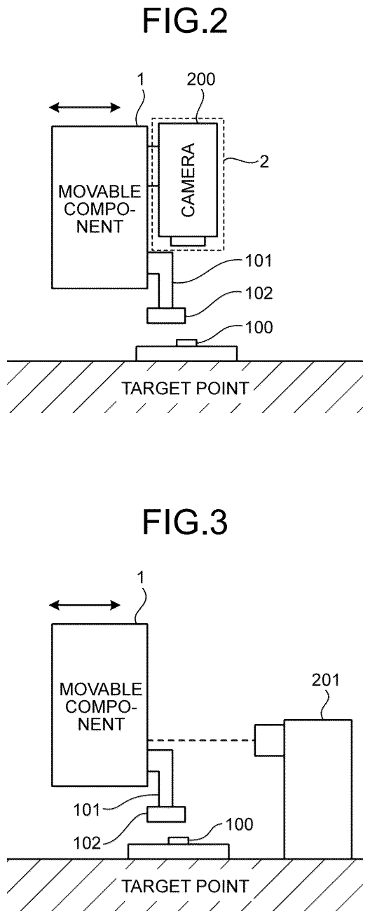

An operation of the motor control device 300 illustrated in FIG. 1 will next be described. The motor control device 300 includes, as illustrated in FIG. 2, a camera 200 as the machine-end sensor 2. FIG. 2 is a diagram illustrating an example of relationship between the movable component 1 and the machine-end sensor 2 of the motor control device 300 according to the first embodiment. In FIG. 2, the arrow represents the directions of movement of the movable component 1. In the example illustrated in FIG. 2, the camera 200, which functions as the machine-end sensor 2, is attached to the movable component 1 to be able to capture an image of the target point 100 when the movable component 1 comes near the target point 100. In addition, a mounting nozzle 101 capable of adsorbing an electronic part 102 is attached to the movable component 1. A configuration may also be used in which an examiner or the like is attached instead of the mounting nozzle 101. The motor control device 300 thus positions the movable component 1 at the target point 100, and performs tasks such as release of the electronic part 102 adsorbed, onto the target point 100, or bringing the examiner attached instead of the mounting nozzle 101 into contact with the target point 100 to examine the target point 100. Such tasks need high accuracy, and thus require positioning of the electronic part 102 adsorbed by the mounting nozzle 101 (or the examiner) with respect to the target point 100 with high accuracy, that is, require positioning of the movable component 1 with respect to the target point 100 with high accuracy.

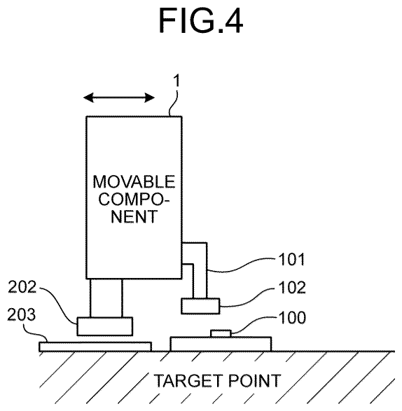

As examples of other configuration, the motor control device 300 may also be configured as illustrated in FIGS. 3 and 4. The motor control device 300 having an exemplary configuration illustrated in FIG. 3 includes a laser displacement meter 201, which is installed at a position fixed against the target point 100 to thereby enable measurement of the position of the movable component 1 relative to the target point 100. In the example illustrated in FIG. 3, the laser displacement meter 201 corresponds to the machine-end sensor 2 illustrated in FIG. 1. In addition, the motor control device 300 having an exemplary configuration illustrated in FIG. 4 includes a reader unit 202 of a linear scale and a scale unit 203 of the linear scale. The reader unit 202 is attached to the movable component 1 and the scale unit 203 is installed at a position fixed against the target point 100 to thereby enable measurement of the position of the movable component 1 relative to the target point 100. In the example illustrated in FIG. 4, the reader unit 202 and the scale unit 203 of the linear scale together correspond to the machine-end sensor 2 illustrated in FIG. 1.

The motor 3 is a drive source of the movable component 1. The motor 3 generates torque according to the motor torque command output by the FF controller 7 to move the movable component 1. The FF controller 7 calculates an ideal torque that is to be output by the motor 3, through calculation corresponding to second-order differential of the position command, where the position command is a command signal for moving the movable component 1 to the target point 100. The FF controller 7 then outputs the result of calculation as the motor torque command. That is, the movable component 1 is moved to the target point 100 on the basis of the position command. Note, however, that even when the motor 3 generates torque according to the motor torque command, friction and/or another disturbance causes the motor position, i.e., the position of the movable component 1, to have a following error with respect to the position specified by the position command. Accordingly, the encoder 4 detects the position of the motor 3, and outputs the detected position as the motor position detection value signal, and the FF controller 7 calculates, from the position command, an ideal position that is to be reached by the motor 3, and outputs the result of calculation as the motor position command. The position signal subtractor 6 calculates the position error signal, which is a difference of the motor position detection value signal relative to this motor position command, and represents an error between the position of the movable component 1 and the target point 100. The position error signal is then input to the FB controller 9. The FB controller 9 calculates the FB torque command to cause the position error signal to be reduced to zero, and the motor 3 generates torque depending on this FB torque command. That is, the motor 3 generates torque according to a torque command, which is generated by addition of the motor torque command calculated by the FF controller 7 and the FB torque command calculated by the FB controller 9. The addition is performed by the torque signal adder 10. The motor 3 thus moves the movable component 1 to follow the position command.

In this respect, when the motor 3 is caused to generate torque only according to the position command and to the motor position detection value signal output by the encoder 4, a situation such as deformation of the machine or positional deviation of the target point 100 will cause an error between the movable component 1 and the target point 100. Thus, in the motor control device 300, the machine-end sensor 2 detects a relative positional relationship between the target point 100 and the movable component 1, and outputs the result of detection as a measurement value signal. The signal processor 11 calculates the position of the movable component 1 relative to the position of the target point 100 on the basis of the measurement value signal output by the machine-end sensor 2, and outputs the result of calculation as the machine-end position detection value signal. This processing will be described below with reference to FIGS. 2, 3, and 4, which illustrate examples of configuration of the machine-end sensor 2 included in the motor control device 300.

When components including the machine-end sensor 2 and the movable component 1 are configured as illustrated in FIG. 2, the camera 200 captures an image of the target point 100, and sends the image to the signal processor 11 as the measurement value signal. The signal processor 11 detects the position of the target point 100 from the image input as the measurement value signal, calculates the position of the electronic part 102 when the target point 100 is used as a reference, and outputs the result of calculation as the machine-end position detection value signal. Note that the relationship between the electronic part 102 and the movable component 1 is fixed, the signal processor 11 therefore may generate and output a machine-end position detection value signal representing the position of the movable component 1 with the target point 100 used as a reference. In this case, the value of the position command input to the FF controller 7 is a value generated by taking into consideration the positional relationship between the movable component 1 and the electronic part 102 adsorbed by the mounting nozzle 101 provided on the movable component 1. For simplicity, the following description assumes that the machine-end position detection value signal represents the position of the movable component 1.

Alternatively, when components including the machine-end sensor 2 and the movable component 1 are configured as illustrated in FIG. 3, the laser displacement meter 201 at a position fixed against the target point 100 measures the position of the movable component 1, and the laser displacement meter 201 sends a signal representing the result of that measurement to the signal processor 11 as the measurement value signal. The signal processor 11 calculates the position of the movable component 1 with the target point 100 used as a reference based on the position of the movable component 1 obtained by the measurement, and outputs the result of calculation as the machine-end position detection value signal.

Further alternatively, when components including the machine-end sensor 2 and the movable component 1 are configured as illustrated in FIG. 4, the reader unit 202 of a linear scale attached to the movable component 1 reads the scale unit 203 of the linear scale installed at a position fixed against the target point 100 to measure the position of the movable component 1, and the reader unit 202 sends the result of that measurement to the signal processor 11 as the measurement value signal. The signal processor 11 calculates the position of the movable component 1 with the target point 100 used as a reference based on the position of the movable component 1 obtained by the measurement, and outputs the result of calculation as the machine-end position detection value signal.

Note that although the present embodiment assumes that the machine-end sensor 2 and the signal processor 11 are separate components, the machine-end sensor 2 and the signal processor 11 may constitute a single integrated component. For example, the machine-end sensor 2 may be configured to include the signal processor 11. That is, the machine-end sensor 2 may be configured to calculate the position of the movable component 1 with the target point 100 used as a reference, and to output the machine-end position detection value signal.

Moving the motor to reduce or eliminate the error that will be caused between the movable component 1 and the target point 100, using the machine-end position detection value signal calculated as described above can reduce or eliminate the error that will be caused between the movable component 1 and the target point 100. However, due to a long time required for transferring the result of measurement performed by the machine-end sensor 2 to the signal processor 11 and a long time required for the signal processor 11 to perform signal processing and to output the machine-end position detection value signal, that is, due to a long dead time, performing highly responsive FB control using only the machine-end position detection value signal will destabilize the FB control system.

To address this problem, the motor control device 300 extracts only low frequency components of the machine-end position detection value signal using the first low-pass filter 12, which passes a signal having a frequency lower than or equal to a predetermined frequency, and extracts only high frequency components from the motor position detection value signal using the first high-pass filter 13, which passes a signal having a frequency higher than or equal to a predetermined frequency. The motor control device 300 then uses the resulting signals in the FB control. The low frequency components of the machine-end position detection value signal and the high frequency components of the motor position detection value signal are added together by the adder 14, and the resulting signal is output as the target point detection value signal. When the error between the movable component 1 and the target point 100 does not vary in an oscillatory manner, such error is represented by a low frequency component, and information thereof thus remains in the low frequency components of the machine-end position detection value signal. In addition, a dead time merely has a small effect on the FB control in low frequencies, thereby allowing destabilization of the FB control to be reduced or prevented. Moreover, use of the high frequency components of the motor position detection value signal in the FB control enables highly responsive FB control to be provided.

Another problem in use of the machine-end sensor 2 as the sensor for use in positioning control is limitation on the area that enables measurement of the relative positional relationship between the target point 100 and the movable component 1. When the target point 100 or the movable component 1 moves into the area that enables measurement of the relative positional relationship, the machine-end sensor 2 outputs a measurement value signal including information of the relative positional relationship between the target point 100 and the movable component 1, thereby enabling the signal processor 11 to calculate the position of the movable component 1 with the position of the target point 100 used as a reference. Thus, control is performed using the motor position detection value signal until the machine-end sensor 2 can measure the relative positional relationship between the target point 100 and the movable component 1, and when the relative positional relationship between the target point 100 and the movable component 1 becomes obtainable, control is switched to control performed using the target point detection value signal. Specifically, in the motor control device 300, the detection value signal switcher 5 switches the signal for use in the FB control. The switching determiner 19 makes a determination of switching, that is, determines whether the machine-end sensor 2 can obtain the relative positional relationship between the target point 100 and the movable component 1 on the basis of the motor position detection value signal, and instructs the detection value signal switcher 5 about switching of the signal depending on the result of determination. That is, the switching determiner 19 calculates the position of the movable component 1 on the basis of the motor position detection value signal, and when the switching determiner 19 determines that the movable component 1 has come near the target point 100 sufficiently for the machine-end sensor 2 to obtain the relative positional relationship between the target point 100 and the movable component 1, the switching determiner 19 instructs the detection value signal switcher 5 to switch to output the target point detection value signal.

When the switching determiner 19 determines that the movable component 1 has come near the target point 100 sufficiently for the machine-end sensor 2 to obtain the relative positional relationship between the target point 100 and the movable component 1, and the detection value signal switcher 5 switches the signal upon receiving an instruction from the switching determiner 19, the signal input to the position signal subtractor 6 is switched from the motor position detection value signal to the target point detection value signal. At this moment, there is a possibility that the position error signal input to the FB controller 9 may rapidly change to cause the FB torque command output by the FB controller 9 to change significantly. A significant change in the FB torque command may exert an impact on the movable component 1, and accordingly needs to be reduced or prevented. To this end, the motor control device 300 changes the motor position command, which is another input to the position signal subtractor 6, using the command value switcher 8. This operation will be described below. The motor control device 300 causes the motor position command delayer 15 to add, to the motor position command, a delay equivalent to the dead time from measurement performed by the machine-end sensor 2 until the signal processor 11 outputs the machine-end position detection value signal. The motor control device 300 then extracts only low frequency components of the delayed motor position command using the second low-pass filter 16, which passes a signal having a frequency lower than or equal to a predetermined frequency. The frequency in this operation is the same frequency as the frequency used by the first low-pass filter 12, and the signal having the low frequency components of the motor position command delayed by the motor position command delayer 15 corresponds to a command signal associated with the low frequency components of the machine-end position detection value signal. In addition, the motor control device 300 extracts only high frequency components of the motor position command using the second high-pass filter 17, which passes a signal having a frequency higher than or equal to a predetermined frequency. The frequency in this operation is the same frequency as the frequency used by the first high-pass filter 13, and the signal having the high frequency components of the motor position command corresponds to a command signal associated with the high frequency components of the motor position detection value signal. The two signals respectively output from the second low-pass filter 16 and the second high-pass filter 17 are then added together by the adder 18, and the resulting signal is output to the command value switcher 8 as the target point command. This signal corresponds to a command signal associated with the target point detection value signal. In addition, simultaneously with switching of the signal performed by the detection value signal switcher 5, the command value switcher 8 switches the signal from the motor position command to the target point command according to the determination made by the switching determiner 19, and outputs the target point command.

That is, when the switching determiner 19 determines that the movable component 1 has come near the target point 100 sufficiently for the machine-end sensor 2 to obtain the relative positional relationship between the target point 100 and the movable component 1, the switching determiner 19 instructs the detection value signal switcher 5 and the command value switcher 8 to switch the signal to be output. Upon reception of the instruction from the switching determiner 19, the detection value signal switcher 5 changes internal setting to output the target point detection value signal input from the adder 14. Upon reception of the instruction from the switching determiner 19, the command value switcher 8 changes internal setting to output the target point command input from the adder 18.

The switching determiner 19 operates as described above to switch the signal output by the detection value signal switcher 5 and the signal output by the command value switcher 8. This causes the position signal subtractor 6 to calculate an error of the motor position detection value signal relative to the motor position command, and inputs the position error signal, which is the result of the calculation, to the FB controller 9 when the relative positional relationship between the target point 100 and the movable component 1 is unmeasurable by the machine-end sensor 2, that is, when the distance from the target point 100 to the movable component 1 is greater than a predetermined value. Otherwise, when the relative positional relationship between the target point 100 and the movable component 1 is measurable by the machine-end sensor 2, the position signal subtractor 6 calculates an error of the target point detection value signal relative to the target point command, and inputs the position error signal, which is the result of the calculation, to the FB controller 9. The FB controller 9 calculates the FB torque command for correcting the position of the movable component 1, on the basis of the position error signal input from the position signal subtractor 6.

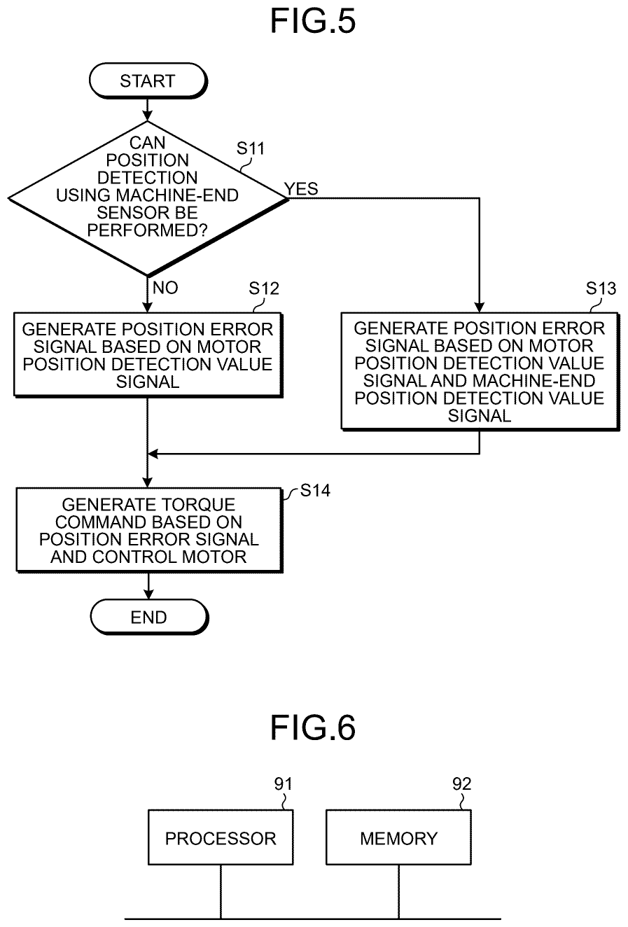

The foregoing operation of the motor control device 300 is illustrated in a flowchart of FIG. 5. Note that FIG. 5 is a flowchart illustrating an example of operation of the motor control device 300 according to the first embodiment.

The motor control device 300 first determines whether position detection using the machine-end sensor 2 can be performed, i.e., whether the relative positional relationship between the target point 100 and the movable component 1 is measurable by the machine-end sensor 2 (step S11). This determination is made by the switching determiner 19 on the basis of the motor position detection value signal, which represents the position of the motor 3 detected by the encoder 4.

When the relative positional relationship between the movable component 1 and the target point 100 is unmeasurable by the machine-end sensor 2 (step S11: No), the motor control device 300 generates a position error signal representing an error between the position of the movable component 1 and the target point 100, on the basis of the motor position detection value signal (step S12). Alternatively, when the relative positional relationship between the target point 100 and the movable component 1 is measurable by the machine-end sensor 2 (step S11: Yes), the motor control device 300 generates the position error signal on the basis of the motor position detection value signal and on the basis of the machine-end position detection value signal representing the position of the movable component 1 with the target point 100 used as a reference (step S13).

After generating the position error signal by performing step $12 or step S13, the motor control device 300 corrects the motor torque command for the motor 3 on the basis of the position error signal, and generates a torque command to control the motor 3 (step S14).

The motor control device 300 repeats the operations at steps S11 to S14 to bring the movable component 1 near the target point 100.

As described above, in the motor control device 300 according to the present embodiment, before the relative positional relationship between the target point 100 and the movable component 1 becomes measurable by the machine-end sensor 2, the FB controller 9 calculates the FB torque command for correcting the position of the movable component 1, using the motor position detection value signal representing the position of the motor 3 detected by the encoder 4, while after the relative positional relationship between the target point 100 and the movable component 1 becomes measurable by the machine-end sensor 2, the FB controller 9 calculates the FB torque command using the target point detection value signal, which is calculated using the machine-end position detection value signal and the motor position detection value signal, where the machine-end position detection value signal represents the position of the movable component 1 with the target point 100 used as a reference, detected on the basis of the measurement value signal representing the result of measurement performed by the machine-end sensor 2. This enables control to be performed to reduce the error between the movable component 1 and the target point 100 to zero. In addition, the motor position command and the target point command are switched from one to another for use in the FB control, simultaneously with switching between the motor position detection value signal and the target point detection value signal. This enables a rapid change in the input to the FB controller 9 to be reduced or prevented, and enables occurrence of a significant change in the FB torque command to be prevented upon signal switching. According to the motor control device 300 according to the present embodiment, fast and accurate positioning can be provided even when the motor control device 300 is configured to use a sensor having a long dead time in position detection or having a limitation on detection area, as the machine-end sensor 2 to detect a positional deviation between the movable component 1 and the target point 100.

Note that the present embodiment has been described in which the switching determiner 19 determines whether the relative positional relationship between the target point 100 and the movable component 1 is measurable by the machine-end sensor 2, on the basis of the motor position detection value signal, but this determination may be made using the position command, the motor position command, or the machine-end position detection value signal.

In addition, in the present embodiment, the switching determiner 19 has been described as determining whether the relative positional relationship between the target point 100 and the movable component 1 is measurable by the machine-end sensor 2 and then switching the signal output by each of the detection value signal switcher 5 and the command value switcher 8. However, the switching may be performed at any time when the relative positional relationship between the target point 100 and the movable component 1 is measurable by the machine-end sensor 2. For example, the switching determiner 19 may compare the motor position detection value signal, the position command, the motor position command, or the machine-end position detection value signal with a preset threshold, and then determine to cause switching when the distance from the movable component 1 to the target point 100 reaches a predetermined value.

Moreover, the first low-pass filter 12 and the second low-pass filter 16 are desirably configured to use a same frequency for passing the signals, but may be configured to use different frequencies. Similarly, the first high-pass filter 13 and the second high-pass filter 17 are desirably configured to use a same frequency for passing the signals, but may be configured to use different frequencies.

A hardware configuration of the motor control device 300 will next be described. The motor control device 300 is configured, as described above, in an appropriate combination of operational circuits such as an adder and a subtractor, filter circuits such as a high-pass filter and a low-pass filter, a switcher, a delayer, an encoder, a camera, a laser displacement meter, and/or the like. In addition, the FF controller 7, the FB controller 9, the signal processor 11, and the switching determiner 19 are configured by a dedicated processing circuitry or by a general-purpose processor that executes a program. Examples of the dedicated processing circuitry include an application specific integrated circuit (ASIC), a field programmable gate array (FPGA), and a circuit in combination thereof. Alternatively, when the FF controller 7, the FB controller 9, the signal processor 11, and the switching determiner 19 are configured by a general-purpose processor, a control circuit consisting of a processor 91 and a memory 92 illustrated in FIG. 6 is used by way of example. FIG. 6 is a diagram illustrating an example of control circuit usable to implement the motor control device 300 according to the first embodiment. The processor 91 is a central processing unit (CPU) (also known as a processing unit, a computing unit, a microprocessor, a microcomputer, and a digital signal processor (DSP)), a system large scale integration (LSI), or the like. The memory 92 is a random access memory (RAM), a read-only memory (ROM), an erasable programmable read-only memory (EPROM), an electrically erasable programmable read-only memory (EEPROM) (registered trademark), or the like. The memory 92 stores a program describing functionality of each of the FF controller 7, the FB controller 9, the signal processor 11, and the switching determiner 19. The processor 91 executes a program stored in the memory 92 to thus operate as the FF controller 7, the FB controller 9, the signal processor 11, and the switching determiner 19. Note that the FF controller 7, the FB controller 9, the signal processor 11, and the switching determiner 19 may be implemented partly in a dedicated processing circuitry such as an ASIC, and the rest thereof may be implemented in the control circuit illustrated in FIG. 6.

### Second Embodiment.

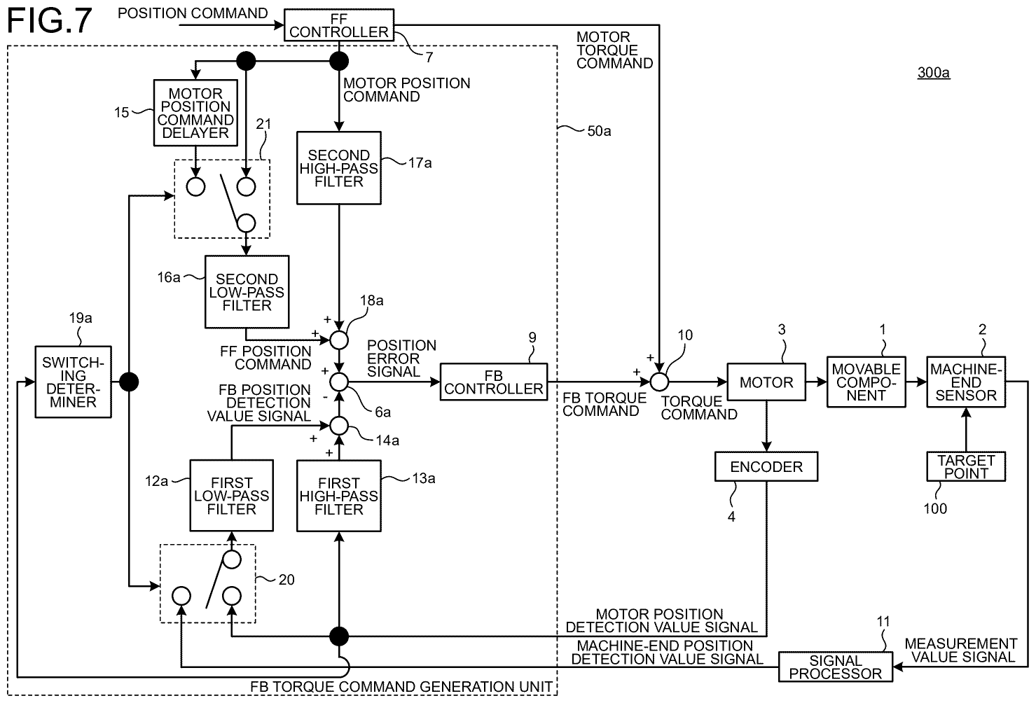

FIG. 7 is a block diagram illustrating an exemplary configuration of a motor control device 300a according to a second embodiment.

The motor control device 300a illustrated in FIG. 7 includes a processing block for generating the position error signal, which is to be an input signal to the FB controller 9. This processing block is configured differently from the corresponding processing block of the motor control device 300 according to the first embodiment illustrated in FIG. 1. Specifically, the motor control device 300a is configured to include a position signal subtractor 6a, a first low-pass filter 12a, a first high-pass filter 13a, an adder 14a, a second low-pass filter 16a, a second high-pass filter 17a, an adder 18a, a switching determiner 19a, a first switcher 20, and a second switcher 21 in place of the detection value signal switcher 5, the position signal subtractor 6, the command value switcher 8, the first low-pass filter 12, the first high-pass filter 13, the adder 14, the second low-pass filter 16, the second high-pass filter 17, the adder 18, and the switching determiner 19 of the motor control device 300. Other components indicated by an identical reference character are similar to the corresponding components of FIG. 1, and description thereof will therefore be omitted.

Note that in the motor control device 300a, the position signal subtractor 6a, the FB controller 9, the first low-pass filter 12a, the first high-pass filter 13a, the adders 14a and 18a, the motor position command delayer 15, the second low-pass filter 16a, the second high-pass filter 17a, the switching determiner 19a, the first switcher 20, and the second switcher 21 constitute a FB torque command generation unit 50a.

An operation of the motor control device 300a illustrated in FIG. 7 will next be described. The first switcher 20 receives the motor position detection value signal and the machine-end position detection value signal. The first switcher 20 outputs one signal of these two input signals. The first low-pass filter 12a passes a signal having a frequency lower than or equal to a predetermined frequency, of the output of the first switcher 20, and inputs the signal passed thereby to the adder 14a. The first high-pass filter 13a passes a signal having a frequency higher than or equal to a predetermined frequency, of the motor position detection value signal, and inputs the signal passed thereby to the adder 14a. The adder 14a adds the two signals input, to generate and output a FB position detection value signal. The switching determiner 19a determines which is to be output from the first switcher 20, of the motor position detection value signal and the machine-end position detection value signal, on the basis of the motor position detection value signal. In this respect, the first low-pass filter 12a and the first high-pass filter 13a are configured to cause the result of addition of the motor position detection value signal that has passed the first low-pass filter 12a and the motor position detection value signal that has passed the first high-pass filter 13a to be identical to the motor position detection value signal that has just been output from the encoder 4 when the first switcher 20 outputs the motor position detection value signal. This enables the adder 14a to output the motor position detection value signal as the FB position detection value signal when the relative positional relationship between the target point 100 and the movable component 1 is unmeasurable by the machine-end sensor 2, and to output a signal corresponding to the target point detection value signal described in the first embodiment as the FB position detection value signal when the relative positional relationship between the target point 100 and the movable component 1 becomes measurable by the machine-end sensor 2.

The second switcher 21 receives the motor position command and the delayed motor position command output by the motor position command delayer 15. The second switcher 21 outputs one signal of these two input signals. The second low-pass filter 16a passes a signal having a frequency lower than or equal to a predetermined frequency, of the output of the second switcher 21, and inputs the signal passed thereby to the adder 18a. The second high-pass filter 17a passes a signal having a frequency higher than or equal to a predetermined frequency, of the motor position command, and inputs the signal passed thereby to the adder 18a. The adder 18a adds the two signals input, to generate and output a FF position command. The switching determiner 19a provides control to switch the signal to be output by the second switcher 21 simultaneously with the timing of switching of the signal to be output by the first switcher 20 described above, on the basis of the motor position detection value signal. Specifically, the switching determiner 19a controls the first switcher 20 and the second switcher 21 to cause the output of the second switcher 21 to switch from the motor position command to the delayed motor position command simultaneously with when the output of the first switcher 20 switches from the motor position detection value signal to the machine-end position detection value signal. In this respect, the second low-pass filter 16a and the second high-pass filter 17a are configured to cause the result of addition of the motor position detection value signal that has passed the second low-pass filter 16a and the motor position command that has passed the second high-pass filter 17a to be identical to the motor position command that has just been output from the FF controller 7 when the second switcher 21 outputs the motor position command. This enables the adder 18a to output the motor position command as the FF position command when the relative positional relationship between the target point 100 and the movable component 1 is unmeasurable by the machine-end sensor 2, and to output a signal corresponding to the target point command described in the first embodiment as the FF position command when the relative positional relationship between the target point 100 and the movable component 1 becomes measurable by the machine-end sensor 2.

The position signal subtractor 6a calculates a difference of the FB position detection value signal relative to the FF position command to generate the position error signal, and inputs the position error signal to the FB controller 9. The FB controller 9 calculates the FB torque command for correcting the position of the movable component 1, on the basis of the position error signal.

As described above, in the motor control device 300a according to the present embodiment, before the relative positional relationship between the target point 100 and the movable component 1 becomes measurable by the machine-end sensor 2, the FB controller 9 calculates the FB torque command for correcting the position of the movable component 1, using the FB position detection value signal that corresponds to the motor position detection value signal, which represents the position of the motor 3 detected by the encoder 4, while after the relative positional relationship between the target point 100 and the movable component 1 becomes measurable by the machine-end sensor 2, the FB controller 9 calculates the FB torque command using the FB position detection value signal that corresponds to the target point detection value signal described in the first embodiment, calculable from the machine-end position detection value signal and from the motor position detection value signal. This enables control to be performed to reduce the error between the movable component 1 and the target point 100 to zero. In addition, the switching determiner 19a controls the first switcher 20 and the second switcher 21 to cause the signal that is to be output by the adder 14a as the FB position detection value signal to be switched simultaneously with the timing of switching of the signal that is to be output by the adder 18a as the FF position command. This enables a rapid change in the input to the FB controller 9 to be reduce or prevented, and enables occurrence of a significant change in the FB torque command to be prevented upon signal switching, resulting in a stable positioning control being provided. In addition, passing of the output of the first switcher 20 through the first low-pass filter 12a, and passing of the output of the second switcher 21 through the second low-pass filter 16a enables a rapid change in a value that may be caused by signal switching to be reduced or prevented, and thus enables stable positioning control to be provided.

Note that the present embodiment has been described in which the switching determiner 19a determines whether the relative positional relationship between the target point 100 and the movable component 1 is measurable by the machine-end sensor 2, on the basis of the motor position detection value signal, but this determination may be made using the position command, the motor position command, or the machine-end position detection value signal.

In addition, the switching determiner 19a has been described as determining whether the relative positional relationship between the target point 100 and the movable component 1 is measurable by the machine-end sensor 2 and then switching the signal output by each of the first switcher 20 and the second switcher 21. However, the switching may be performed at any time when the relative positional relationship between the target point 100 and the movable component 1 is measurable by the machine-end sensor 2. For example, the switching determiner 19a may compare the motor position detection value signal, the position command, the motor position command, or the machine-end position detection value signal with a preset threshold, and then determine to cause switching when the distance from the movable component 1 to the target point 100 reaches a predetermined value.

Moreover, the first low-pass filter 12a and the second low-pass filter 16a are desirably configured to use a same frequency for passing the signals, but may be configured to use different frequencies. Similarly, the first high-pass filter 13a and the second high-pass filter 17a are desirably configured to use a same frequency for passing the signals, but may be configured to use different frequencies.

### Third Embodiment.

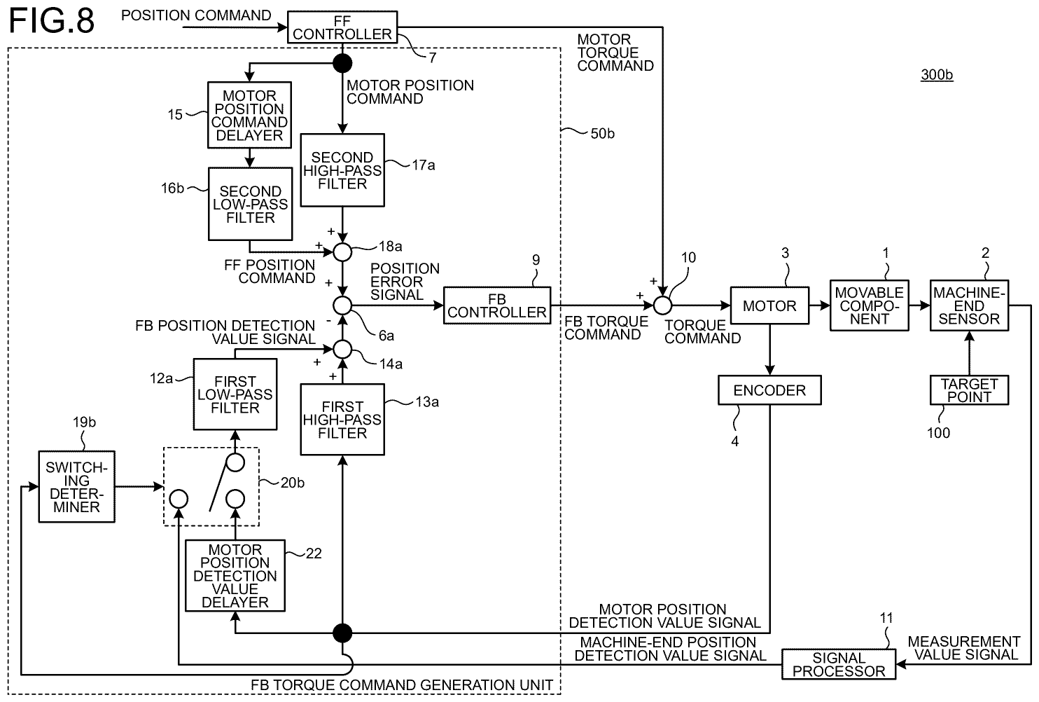

FIG. 8 is a block diagram illustrating an exemplary configuration of a motor control device 300b according to a third embodiment.

The motor control device 300b illustrated in FIG. 8 includes a processing block for generating the position error signal, which is to be an input signal to the FB controller 9. This processing block is configured differently from the corresponding processing block of the motor control device 300a according to the second embodiment illustrated in FIG. 7. Specifically, the motor control device 300b is configured to include a second low-pass filter 16b, a switching determiner 19b, and a switcher 20b in place of the second low-pass filter 16a, the switching determiner 19a, and the first switcher 20 of the motor control device 300a; additionally include a motor position detection value delayer 22; and not to include the second switcher 21. Other components indicated by an identical reference character are similar to the corresponding components of FIG. 7, and description thereof will therefore be omitted.

Note that in the motor control device 300b, the position signal subtractor 6a, the FB controller 9, the first low-pass filter 12a, the first high-pass filter 13a, the adders 14a and 18a, the motor position command delayer 15, the second low-pass filter 16b, the second high-pass filter 17a, the switching determiner 19b, the switcher 20b, and the motor position detection value delayer 22 constitute a FB torque command generation unit 50b.

An operation of the motor control device 300b illustrated in FIG. 8 will next be described. The motor position detection value delayer 22 adds a predetermined time delay to the motor position detection value signal input from the encoder 4, and outputs the resulting signal to the switcher 20b. The motor position detection value delayer 22 adds, to the motor position detection value signal, a time delay based on a dead time corresponding to the time required from measurement performed by the machine-end sensor 2 until the signal processor 11 outputs the machine-end position detection value signal, thereby enabling the motor position detection value signal to include a dead time equivalent to the dead time of the machine-end position detection value signal. The first low-pass filter 12a passes a signal having a frequency lower than or equal to a predetermined frequency, of the output of the switcher 20b, and inputs the signal passed thereby to the adder 14a. The first high-pass filter 13a passes a signal having a frequency higher than or equal to a predetermined frequency, of the motor position detection value signal, and inputs the signal passed thereby to the adder 14a. The adder 14a adds the two signals input, to generate and output the FB position detection value signal. The switching determiner 19b determines which is to be output from the switcher 20b, of the motor position detection value signal delayed by adding the time delay by the motor position detection value delayer 22 and the machine-end position detection value signal, on the basis of the motor position detection value signal.

The second low-pass filter 16b passes a signal having a frequency lower than or equal to a predetermined frequency, of the motor position command delayed by adding a time delay by the motor position command delayer 15, and inputs the signal passed thereby to the adder 18a. The second high-pass filter 17a passes a signal having a frequency higher than or equal to a predetermined frequency, of the motor position command, and inputs the signal passed thereby to the adder 18a. The adder 18a adds the two signals input, to generate and output the FF position command.

The position signal subtractor 6a calculates a difference of the FB position detection value signal relative to the FF position command to generate the position error signal, and inputs the position error signal to the FB controller 9. The FB controller 9 calculates the FB torque command for correcting the position of the movable component 1, on the basis of the position error signal.

In this operation, the value of the signal that has passed the first low-pass filter 12a and the value of the signal that has passed the second low-pass filter 16b each include the dead time or a time delay having a length the same as the dead time. This enables control to be performed to cause high frequency components of the FF position command to be followed by high frequency components of the motor position detection value signal, and low frequency components of the FF position command to be followed by low frequency components of the delayed motor position detection value signal or of the machine-end position detection value signal. The switching determiner 19b switches the setting of the switcher 20b to cause a value calculated from only the motor position detection value signal to be output from the adder 14a as the FB position detection value signal when the relative positional relationship between the target point 100 and the movable component 1 is unmeasurable by the machine-end sensor 2, and to cause a value calculated from both the motor position detection value signal and the machine-end position detection value signal to be output from the adder 14a as the FB position detection value signal when the relative positional relationship between the target point 100 and the movable component 1 becomes measurable by the machine-end sensor 2. This enables the motor control device 300b to perform control to reduce the error between the movable component 1 and the target point 100 to zero.

As described above, in the motor control device 300b according to the present embodiment, before the relative positional relationship between the target point 100 and the movable component 1 becomes measurable by the machine-end sensor 2, the FB controller 9 calculates the FB torque command for correcting the position of the movable component 1, using the motor position detection value signal representing the position of the motor 3 detected by the encoder 4, while after the relative positional relationship between the target point 100 and the movable component 1 becomes measurable by the machine-end sensor 2, the FB controller 9 calculates the FB torque command using the FB position detection value signal calculated from the machine-end position detection value signal and from the motor position detection value signal. This enables control to be performed to reduce the error between the movable component 1 and the target point 100 to zero. In addition, elimination of switching of the FF position command regardless of the value of the FB position detection value signal can simplify the control system. Moreover, adding a time delay equivalent to the dead time included in the machine-end position detection value signal to the motor position detection value signal to be input to the switcher 20b, and passing the output of the switcher 20b through the first low-pass filter 12a enables a rapid change in a value that may be caused by switching of the output signal performed by the switcher 20b to be reduced or prevented, and thus enables stable positioning control to be provided.

Note that the present embodiment has been described in which the switching determiner 19b determines whether the relative positional relationship between the target point 100 and the movable component 1 is measurable by the machine-end sensor 2, on the basis of the motor position detection value signal, but this determination may be made using the position command, the motor position command, or the machine-end position detection value signal.

In addition, the switching determiner 19b has been described as determining whether the relative positional relationship between the target point 100 and the movable component 1 is measurable by the machine-end sensor 2 and then switching the signal output by the switcher 20b. However, the switching may be performed at any time when the relative positional relationship between the target point 100 and the movable component 1 is measurable by the machine-end sensor 2. For example, the switching determiner 19b may compare the motor position detection value signal, the position command, the motor position command, or the machine-end position detection value signal with a preset threshold, and then determine to cause switching when the distance from the movable component 1 to the target point 100 reaches a predetermined value.

Moreover, the first low-pass filter 12a and the second low-pass filter 16b are desirably configured to use a same frequency for passing the signals, but may be configured to use different frequencies. Similarly, the first high-pass filter 13a and the second high-pass filter 17a are desirably configured to use a same frequency for passing the signals, but may be configured to use different frequencies.

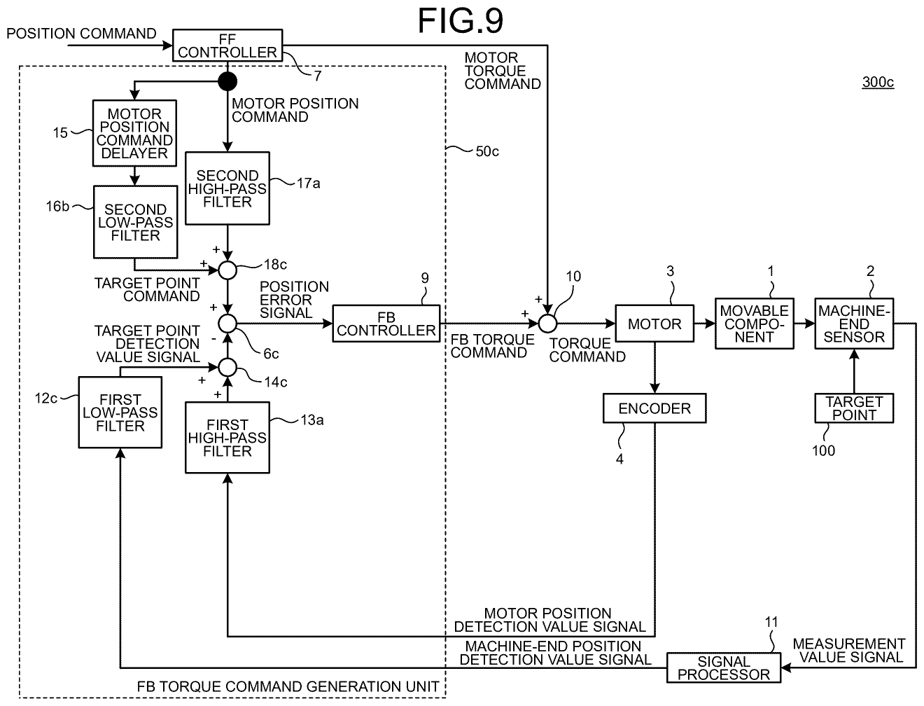

### Fourth Embodiment. FIG. 9 is a block diagram illustrating an exemplary configuration of a motor control device 300c according to a fourth embodiment.

The motor control device 300c illustrated in FIG. 9 includes a processing block for generating the position error signal, which is to be an input signal to the FB controller 9. This processing block is configured differently from the corresponding processing block of the motor control device 300b according to the third embodiment illustrated in FIG. 8. Specifically, the motor control device 300c is configured to include a position signal subtractor 6c, a first low-pass filter 12c, an adder 14c, and an adder 18c in place of the position signal subtractor 6a, the first low-pass filter 12a, the adder 14a, and the adder 18a of the motor control device 300b, and not to include the switcher 20b, the switching determiner 19b, or the motor position detection value delayer 22. Other components indicated by an identical reference character are similar to the corresponding components of FIG. 8, and description thereof will therefore be omitted.

Note that in the motor control device 300c, the position signal subtractor 6c, the FB controller 9, the first low-pass filter 12c, the first high-pass filter 13a, the adders 14c and 18c, the motor position command delayer 15, the second low-pass filter 16b, and the second high-pass filter 17a constitute a FB torque command generation unit 50c.

An operation of the motor control device 300c illustrated in FIG. 9 will next be described. The first low-pass filter 12c passes a signal having a frequency lower than or equal to a predetermined frequency, of the machine-end position detection value signal, and inputs the signal passed thereby to the adder 14c. The first high-pass filter 13a passes a signal having a frequency higher than or equal to a predetermined frequency, of the motor position detection value signal, and inputs the signal passed thereby to the adder 14c. The adder 14c adds the two signals input, to generate and output the target point detection value signal.

The second low-pass filter 16b passes a signal having a frequency lower than or equal to a predetermined frequency, of the motor position command delayed by adding a time delay by the motor position command delayer 15, and inputs the signal passed thereby to the adder 18c. The second high-pass filter 17a passes a signal having a frequency higher than or equal to a predetermined frequency, of the motor position command, and inputs the signal passed thereby to the adder 18c. The adder 18c adds the two signals input, to generate and output the target point command.

The position signal subtractor 6c calculates a difference of the target point detection value signal relative to the target point command to generate the position error signal, and inputs the position error signal to the FB controller 9. The FB controller 9 calculates the FB torque command for correcting the position of the movable component 1, on the basis of the position error signal.

In this operation, the machine-end position detection value signal that has passed the first low-pass filter 12c includes the dead time, and the motor position command that has passed the second low-pass filter 16b is delayed for a time delay having a length the same as the dead time included in the machine-end position detection value signal. Thus, the FB controller 9 calculates the FB torque command to cause high frequency components of the target point command to be followed by high frequency components of the motor position detection value signal, and low frequency components of the target point command to be followed by low frequency components of the machine-end position detection value signal. This enables control to be performed to reduce the error between the movable component 1 and the target point 100 to zero.

As described above, in the motor control device 300c according to the present embodiment, the FB controller 9 calculates the FB torque command using the target point detection value signal calculated on the basis of the machine-end position detection value signal and of the motor position detection value signal, where the machine-end position detection value signal represents the position of the movable component 1 with the target point 100 used as a reference and based on the measurement value signal output by the machine-end sensor 2. This enables control to be performed to reduce the error between the movable component 1 and the target point 100 to zero. This configuration is a configuration useful when the relative positional relationship between the target point 100 and the movable component 1 is measurable by the machine-end sensor 2. Elimination of switching of the values for use in calculation of the signal for use in FB control and the signal for use in FF control can simplify the control system. In addition, performing no switching of the signals for use in calculation enables a rapid change in a value that may be caused upon signal switching to be reduced or prevented, and thus enables stable positioning control to be provided.

Note that the first low-pass filter 12c and the second low-pass filter 16b are desirably configured to use a same frequency for passing the signals, but may be configured to use different frequencies.

The configurations described in the foregoing embodiments are merely examples. These configurations may be combined with another known technology, and configurations of different embodiments may be combined together. Moreover, part of such configurations may be omitted and/or modified without departing from the spirit thereof.

### REFERENCE SIGNS LIST

1 movable component; 2 machine-end sensor; 3 motor; 4 encoder; 5 detection value signal switcher; 6, 6a, 6c position signal subtractor; 7 FF controller; 8 command value switcher; 9 FB controller; 10 torque signal adder; 11 signal processor; 12, 12a, 12c first low-pass filter; 13, 13a first high-pass filter; 14, 14a, 14c, 18, 18a, 18c adder; 15 motor position command delayer; 16, 16a, 16b second low-pass filter; 17, 17a second high-pass filter; 19, 19a, 19b switching determiner; 20 first switcher; 20b switcher; 21 second switcher; 22 motor position detection value delayer; 50, 50a, 50b, 50c FB torque command generation unit; 100 target point; 101 mounting nozzle; 102 electronic part; 200 camera; 201 laser displacement meter; 202 reader unit; 203 scale unit; 300, 300a, 300b, 300c motor control device.

1. A motor control device that drives a motor on a basis of a position command to move a movable component to a target point specified by the position command, the motor control device comprising:
feedforward control circuitry to generate a motor torque command and a motor position command on a basis of the position command;
an encoder to detect a position of the motor and to output a motor position detection value signal representing the position;
a machine-end sensor to detect a target object present in a certain area including the movable component and output a measurement value signal representing a result of detection;
a signal processor to calculate a position of the movable component with the target point used as a reference on a basis of the measurement value signal and output a machine-end position detection value signal representing a result of calculation;
feedback torque command generation circuitry to generate a feedback torque command for correcting the motor torque command, on a basis of the machine-end position detection value signal, the motor position detection value signal, and the motor position command; and
torque signal adding circuitry to add the motor torque command and the feedback torque command to generate a torque command directed to the motor, wherein
when the machine-end sensor is in a first state, the feedback torque command generation circuitry generates the feedback torque command on a basis of the motor position detection value signal and the motor position command, and when the machine-end sensor is in a second state, the feedback torque command generation circuitry generates the feedback torque command on a basis of the motor position detection value signal, the machine-end position detection value signal, the motor position command, and a signal obtained by adding a time delay to the motor position command, the first state being a state in which a relative positional relationship between the movable component and the target point is undetectable by the machine-end sensor, the second state being a state in which the relative positional relationship between the movable component and the target point is detectable by the machine-end sensor.

2. The motor control device according to claim 1, wherein
the feedback torque command generation circuitry includes
a first low-pass filter to pass a signal component having a frequency lower than or equal to a predetermined frequency, of the machine-end position detection value signal,
a first high-pass filter to pass a signal component having a frequency higher than or equal to a predetermined frequency, of the motor position detection value signal,
first adding circuitry to add an output of the first low-pass filter and an output of the first high-pass filter,
motor position command delaying circuitry to add the time delay to the motor position command and output a resulting signal,
a second low-pass filter to pass a signal component having a frequency lower than or equal to a predetermined frequency, of the resulting signal output by the motor position command delaying circuitry,
a second high-pass filter to pass a signal component having a frequency higher than or equal to a predetermined frequency, of the motor position command,
second adding circuitry to add an output of the second low-pass filter and an output of the second high-pass filter,
detection value signal switching circuitry to receive the motor position detection value signal and a signal output from the first adding circuitry, to output the motor position detection value signal when the machine-end sensor is in the first state, and to output the signal input from the first adding circuitry when the machine-end sensor is in the second state,
command value switching circuitry to receive the motor position command and a signal output from the second adding circuitry, to output the motor position command when the machine-end sensor is in the first state, and to output the signal input from the second adding circuitry when the machine-end sensor is in the second state, and
feedback control circuitry to calculate the feedback torque command on a basis of a difference between an output of the detection value signal switching circuitry and an output of the command value switching circuitry.

3. The motor control device according to claim 2, comprising:
switching determination circuitry to determine whether the machine-end sensor is in the first state or in the second state on a basis of the motor position detection value signal, the machine-end position detection value signal, the position command, or the motor position command, and to control the detection value signal switching circuitry and the command value switching circuitry on a basis of a result of determination.

4. The motor control device according to claim 1, wherein
the feedback torque command generation circuitry includes
first switching circuitry to receive the motor position detection value signal and the machine-end position detection value signal, to output the motor position detection value signal when the machine-end sensor is in the first state, and to output the machine-end position detection value signal when the machine-end sensor is in the second state,
a first low-pass filter to pass a signal component having a frequency lower than or equal to a predetermined frequency, of a signal output by the first switching circuitry,
a first high-pass filter to pass a signal component having a frequency higher than or equal to a predetermined frequency, of the motor position detection value signal,
first adding circuitry to add an output of the first low-pass filter and an output of the first high-pass filter,
motor position command delaying circuitry to add the time delay to the motor position command and to output a resulting signal,
second switching circuitry to receive the motor position command and a signal output from the motor position command delaying circuitry, to output the motor position command when the machine-end sensor is in the first state, and to output the signal input from the motor position command delaying circuitry when the machine-end sensor is in the second state,
a second low-pass filter to pass a signal component having a frequency lower than or equal to a predetermined frequency, of a signal output by the second switching circuitry,
a second high-pass filter to pass a signal component having a frequency higher than or equal to a predetermined frequency, of the motor position command,
second adding circuitry to add an output of the second low-pass filter and an output of the second high-pass filter, and
feedback control circuitry to calculate the feedback torque command on a basis of a difference between an output of the first adding circuitry and an output of the second adding circuitry.

5. The motor control device according to claim 4, comprising:
switching determination circuitry to determine whether the machine-end sensor is in the first state or in the second state on a basis of the motor position detection value signal, the machine-end position detection value signal, the position command, or the motor position command, and to control the first switching circuitry and the second switching circuitry on a basis of a result of determination.

6. The motor control device according to claim 1, wherein
the feedback torque command generation circuitry includes
motor position detection value delaying circuitry to add a time delay to the motor position detection value signal and output a resulting signal,
switching circuitry to receive a signal output from the motor position detection value delaying circuitry and the machine-end position detection value signal, to output the signal input from the motor position detection value delaying circuitry when the machine-end sensor is in the first state, and to output the machine-end position detection value signal when the machine-end sensor is in the second state,
a first low-pass filter to pass a signal component having a frequency lower than or equal to a predetermined frequency, of a signal output by the switching circuitry,
a first high-pass filter to pass a signal component having a frequency higher than or equal to a predetermined frequency, of the motor position detection value signal,
first adding circuitry to add an output of the first low-pass filter and an output of the first high-pass filter,
motor position command delaying circuitry to add the time delay to the motor position command and output a resulting signal,
a second low-pass filter to pass a signal component having a frequency lower than or equal to a predetermined frequency, of the resulting signal output by the motor position command delaying circuitry,
a second high-pass filter to pass a signal component having a frequency higher than or equal to a predetermined frequency, of the motor position command,
second adding circuitry to add an output of the second low-pass filter and an output of the second high-pass filter, and
feedback control circuitry to calculate the feedback torque command on a basis of a difference between an output of the first adding circuitry and an output of the second adding circuitry.

7. The motor control device according to claim 6, comprising:
switching determination circuitry to determine whether the machine-end sensor is in the first state or in the second state on a basis of the motor position detection value signal, the machine-end position detection value signal, the position command, or the motor position command, and to control the switching circuitry on a basis of a result of determination.

8. The motor control device according to claim 1, wherein
the feedback torque command generation circuitry includes
a first low-pass filter to pass a signal component having a frequency lower than or equal to a predetermined frequency, of the machine-end position detection value signal,
a first high-pass filter to pass a signal component having a frequency higher than or equal to a predetermined frequency, of the motor position detection value signal,
first adding circuitry to add an output of the first low-pass filter and an output of the first high-pass filter,
motor position command delaying circuitry to add the time delay to the motor position command and to output a resulting signal,
a second low-pass filter to pass a signal component having a frequency lower than or equal to a predetermined frequency, of the resulting signal output by the motor position command delaying circuitry,
a second high-pass filter to pass a signal component having a frequency higher than or equal to a predetermined frequency, of the motor position command,
second adding circuitry to add an output of the second low-pass filter and an output of the second high-pass filter, and
feedback control circuitry to calculate the feedback torque command on a basis of a difference between an output of the first adding circuitry and an output of the second adding circuitry.

9. The motor control device according to claim 6, wherein
the time delay added to the motor position detection value signal by the motor position detection value delaying circuitry is a time equivalent to a dead time, the dead time being a total time of a time required from when the machine-end sensor detects the target object present in the certain area until the machine-end sensor outputs the measurement value signal and a time required from when the signal processor receives the measurement value signal until the signal processor outputs the machine-end position detection value signal.

10. The motor control device according to claim 2, wherein
the time delay added to the motor position command by the motor position command delaying circuitry is a time equivalent to a dead time, the dead time being a total time of a time required when the machine-end sensor detects the target object present in the certain area until the machine-end sensor outputs the measurement value signal and a time required from when the signal processor receives the measurement value signal until the signal processor outputs the machine-end position detection value signal.

11. The motor control device according to claim 7, wherein
the time delay added to the motor position detection value signal by the motor position detection value delaying circuitry is a time equivalent to a dead time, the dead time being a total time of a time required from when the machine-end sensor detects the target object present in the certain area until the machine-end sensor outputs the measurement value signal and a time required from when the signal processor receives the measurement value signal until the signal processor outputs the machine-end position detection value signal.

12. The motor control device according to claim 3, wherein
the time delay added to the motor position command by the motor position command delaying circuitry is a time equivalent to a dead time, the dead time being a total time of a time required when the machine-end sensor detects the target object present in the certain area until the machine-end sensor outputs the measurement value signal and a time required from when the signal processor receives the measurement value signal until the signal processor outputs the machine-end position detection value signal.

13. The motor control device according to claim 4, wherein
the time delay added to the motor position command by the motor position command delaying circuitry is a time equivalent to a dead time, the dead time being a total time of a time required when the machine-end sensor detects the target object present in the certain area until the machine-end sensor outputs the measurement value signal and a time required from when the signal processor receives the measurement value signal until the signal processor outputs the machine-end position detection value signal.

14. The motor control device according to claim 5, wherein
the time delay added to the motor position command by the motor position command delaying circuitry is a time equivalent to a dead time, the dead time being a total time of a time required when the machine-end sensor detects the target object present in the certain area until the machine-end sensor outputs the measurement value signal and a time required from when the signal processor receives the measurement value signal until the signal processor outputs the machine-end position detection value signal.

15. The motor control device according to claim 6, wherein
the time delay added to the motor position command by the motor position command delaying circuitry is a time equivalent to a dead time, the dead time being a total time of a time required when the machine-end sensor detects the target object present in the certain area until the machine-end sensor outputs the measurement value signal and a time required from when the signal processor receives the measurement value signal until the signal processor outputs the machine-end position detection value signal.

16. The motor control device according to claim 7, wherein
the time delay added to the motor position command by the motor position command delaying circuitry is a time equivalent to a dead time, the dead time being a total time of a time required when the machine-end sensor detects the target object present in the certain area until the machine-end sensor outputs the measurement value signal and a time required from when the signal processor receives the measurement value signal until the signal processor outputs the machine-end position detection value signal.

17. The motor control device according to claim 8, wherein
the time delay added to the motor position command by the motor position command delaying circuitry is a time equivalent to a dead time, the dead time being a total time of a time required when the machine-end sensor detects the target object present in the certain area until the machine-end sensor outputs the measurement value signal and a time required from when the signal processor receives the measurement value signal until the signal processor outputs the machine-end position detection value signal.

18. The motor control device according to claim 9, wherein
the time delay added to the motor position command by the motor position command delaying circuitry is a time equivalent to a dead time, the dead time being a total time of a time required when the machine-end sensor detects the target object present in the certain area until the machine-end sensor outputs the measurement value signal and a time required from when the signal processor receives the measurement value signal until the signal processor outputs the machine-end position detection value signal.

19. The motor control device according to claim 11, wherein
the time delay added to the motor position command by the motor position command delaying circuitry is a time equivalent to a dead time, the dead time being a total time of a time required when the machine-end sensor detects the target object present in the certain area until the machine-end sensor outputs the measurement value signal and a time required from when the signal processor receives the measurement value signal until the signal processor outputs the machine-end position detection value signal.
